(19) United States
(12) Patent Application Publication
(10) Pub. No.: US 2025/0206875 A1
(43) Pub. Date: Jun. 26, 2025

(54) LATENT AMINE COMPOSITIONS FOR FLAME RESISTANT EPOXY SYSTEM

(71) Applicant: EVONIK OPERATIONS GMBH, Essen (DE)

(72) Inventors: Shuanghu Li, Shanghai (CN); Qiubai Peng, Shanghai (CN); Qi Fu, Shanghai (CN)

(73) Assignee: EVONIK OPERATIONS GMBH, Essen (DE)

(21) Appl. No.: 18/848,456

(22) PCT Filed: Mar. 30, 2022
(86) PCT No.: PCT/CN2022/083915

§ 371 Date: Sep. 18, 2024

(51) Int. Cl. C08G 59/40; C08G 59/50; C08G 59/56; C08K 3/32; C08K 7/02

(52) U.S. Cl. CPC C08G 59/4021; C08G 59/5026; C08G 59/56; C08K 3/32; C08K 7/02; C08K 2003/323

(57) ABSTRACT

The present disclosure provides latent amine compositions which are used as a curing agent for flame resistant epoxy systems, the amine-epoxy resin compositions, and the cured products from amine-epoxy composition.

### TECHNICAL FIELD

The present invention relates to latent amine compositions which are used as a curing agent for flame resistant epoxy systems, the amine-epoxy resin compositions, and the cured products from amine-epoxy composition. One-pack type epoxy systems are preferable to the traditional two-pack type epoxy systems because they are free of misformulation and can be used continuously. One-pack type epoxy systems require latent curing agents which do not react with the epoxy compounds at room temperature but react with epoxies to effect curing by heating.

### BACKGROUND OF THE INVENTION

Fiber reinforced composites are used in a wide variety of applications because they have low density and high strength. An example of one such application is in the automotive industry where there is a desire to save fuel by reducing vehicle weight. Fiber reinforced composites provide a material having a lower density while retaining mechanical performance comparable with steel and aluminum.

The demands of the automotive industry require that preparation of the molded part is completed at the speed and automation typically seen at an automotive site. As a result, the epoxy formulation for use in preparing a molded part must have a relatively fast cure rate and must be capable of being processed in an automated system.

Fiber reinforced composites comprise a resin matrix reinforced with fibers and the resin matrix is commonly an epoxy resin. The fiber reinforced composites are prepared in a process where the chopped fibers are impregnated within the resin to form so-called sheet molding compounds (SMC). SMC are commonly described as reinforced composites comprising chopped fibers that are impregnated in a resin that is in an uncured or partially cured state. SMC can then be molded into a final or semifinal molded part by subjecting the SMC to conditions that cure the resin. Heat is used to cure the SMC in a mold at a temperature for a time sufficient to cure the resin.

Examples of articles being evaluated for manufacturing from epoxy resin systems include sheet molding compound (SMC) composites. There are a lot of requirements for effective manufacturing especially when complex manufacturing processes are used. These processes include composite applications such as SMC, prepreg, high pressure resin transfer molding, filament winding and the like.

U.S. Pat. No. 9,862,798 discloses epoxy liquid curing agent compositions comprising dicyandiamide and at least one polyamine.

Chinese Patent Publication No. CN 112063118A discloses a low density flame retardant epoxy resin composition without VOC emission for preparing a sheet molding compound.

There is a need in the art for epoxy systems with good flame resistance and high curing efficiency. Epoxy systems used for composites in the transportation and automotive industries must reach flame resistance requirements. In such industries, flame retardants such as ammonium polyphosphate are used to meet fire resistance requirements because of its high flame resistance and cost efficiency.

Another need in the art is for fast cure of epoxy systems at high temperature. According to the processing properties of SMC composites, epoxy systems must be gelled in 100 s and cured in 10 min at 150-160° C. Fast cure of epoxy systems is highly desired since it reduces the production cycle of composite parts, enabling improved production efficiency. Flame retardants such as ammonium polyphosphate will reduce the reactivity of an amine-based epoxy system, especially in a dicyandiamide curing system. Accordingly, a higher ratio of accelerator is used to meet the fast cure speed requirement. The higher ratio of accelerator will also reduce the Tg and latency of the composites.

Another need in the art is for good latency of epoxy systems at ambient temperature. Epoxy systems used for SMC composites must have more than 30 days shelf life at ambient temperature. According to the processing property of SMC, the material should reach the B-stage after the maturation process, and it should keep relatively stable properties such as Tg and gel time in 30 days to meet the production requirements.

Thus, there is a need in the art for improved curing agents for producing epoxy resin systems which have good flame resistance, fast cure at high temperature, and good latency at ambient temperature, while maintaining desired mechanical properties and good processing properties.

### BRIEF SUMMARY OF THE INVENTION

The present disclosure includes a curing agent composition comprising dicyandiamide, at least one cycloaliphatic amine, at least one additive, at least one urea accelerator, and at least one inorganic alkali used as a reaction promoter. There are several advantages associated with the curing agent compositions of this invention. These advantages include (i) an ability to be formulated with liquid diglycidyl ether of bisphenol A (DGBPA) epoxy resin and a flame retardant, (ii) having fast cure at high temperature, (iii) having stable latency at room temperature, (iv) having good mechanical performance and heat resistance, and (v) having excellent flame resistance performance and good processing properties. Another advantage includes that the latent epoxy system may be used for fiber reinforcing composites.

Another aspect of the present disclosure includes an epoxy system prepared from at least one epoxy resin and a curing agent composition comprising dicyandiamide, at least one cycloaliphatic amine, at least one additive, at least one urea accelerator, and at least one inorganic alkali.

### DETAILED DESCRIPTION OF THE INVENTION

The present invention relates to an inventive curing agent composition comprising dicyandiamide (A), at least one cycloaliphatic amine (B), at least one additive (C), at least one urea accelerator (D) and at least one inorganic alkali (E) and additive (F).

The particle size of the dicyandiamide in the subject curing agent composition needs to be substantially smaller with a narrow size distribution. Preferred examples of particle size of dicyandiamide that can be used in the composition include, but are not limited to, D90<10 micrometers, 10<D90<35 micrometers, 35<D90<100 micrometers, and D90>100 micrometers. In one preferred embodiment, the particle size of dicyandiamide is D90<10 micrometers.

Preferably, the at least one cycloaliphatic amine is selected from the group consisting of metaxylylenediamine (MXDA), 1,3-cyclohexanedimethylamine, N-aminoethylpiperazine (NAEP), isophoronediamine (IPD), methylcyclohexanediamine, cyclohexylpropylenediamine, bis(aminocyclohexyl)methane, 1,2-cyclohexanediamine, 3,3′-dimethyl-4,4-diaminodicyclohexylmethane, other cycloaliphatic amines, and combinations thereof. In one preferred embodiment, the cycloaliphatic amine is isophoronediamine. In this system, preferably polyether diamines, aliphatic amines, aromatic amines, and amido amines can also be used in combination with the cycloaliphatic amine. Preferred polyether amines include the trade names Jeffaminev D230, D400, D2000, available from Huntsman. Although not specifically mentioned, other polyether amines under the tradename designations Jeffamine® D series and T series available from Huntsman or same grade polyether amines from other producers could also be used. Preferred aliphatic amines include Triethylenetetramine (TETA), Diethylenetriamine (DETA), Tetraethylenepentamine (TEPA), other aliphatic amines, and combinations thereof. Preferred aromatic amines include 4,4′-Methylenedianiline (MDA), Diethyltoluenediamine (DETDA), other aromatic amines, and combinations thereof. Preferred amido amines include the trade names Ancamide® 502,503,504,505,506 available from Evonik, other aromatic amines, and combinations thereof.

Preferably, the at least one additive is selected from the group consisting of release agents, defoaming agents, leveling agents, coupling agents, other additives, and combinations thereof.

Preferably, the at least one urea accelerator is selected from the group consisting of 1-phenyl-3,3-dimethyl urea, 1,1′-(4-methyl-m-phenylene) bis(3,3-dimethylurea), 3-(3-chloro-4-methylphenyl)-1,1-dimethylurea, 3-(3,4-dichlorophenyl)-1,1-dimethylurea, 3-(4-chlorophenyl)-1,1-dimethylurea, 4,4′-methylene bis (phenyl dimethyl urea), or urea accelerators, and combinations thereof. In one preferred embodiment, the urea accelerator is 4,4′-methylene bis (phenyl dimethyl urea). In the system, preferably imidazoles and blocked amines can be used in combination with the urea accelerator. Preferred imidazoles include the trade names Ajicure® PN-23, PN-40, PN-40J available from Ajimoto, other modified imidazole, and combinations thereof. Preferred blocked amines include the trade names Ancamine® 2014FG, 2337S, 2014AS, 2441 available from Evonik, other blocked amines, and combinations thereof.

Preferably, the at least one inorganic alkali is selected from the group consisting of calcium carbonate, calcium oxide, calcium hydroxide, magnesium hydroxide, barium hydroxide, potassium hydrate, magnesium oxide, barium oxide, potassium oxide, sodium hydroxide, other inorganic alkali, and combinations thereof. In one preferred embodiment, the inorganic alkali is calcium hydroxide.

In a preferred embodiment, the percentages by weight in the inventive curing agent composition are 1-50% dicyandiamide, 1-50% cycloaliphatic amine, 1-50% additive, 1-30% urea accelerator, and 1-30% inorganic alkali, respectively. In another preferred embodiment, the percentages by weight in the inventive curing agent composition are 10-30% dicyandiamide, 25-40% cycloaliphatic amine, 15-30% additive, 5-15% urea accelerator, and 5-15% inorganic alkali, respectively.

Another aspect of the present disclosure includes an epoxy system prepared from at least one epoxy resin, at least one flame retardant and a curing agent composition comprising dicyandiamide, at least one cycloaliphatic amine, at least one additive, at least one urea accelerator, and at least one inorganic alkali.

Preferably, the at least one epoxy resin is selected from the group consisting of liquid diglycidyl ether of bisphenol A, liquid diglycidyl ether of bisphenol F, phenol novolac epoxy resin, and multifunctional epoxy resin. In one preferred embodiment, the epoxy resin is liquid diglycidyl ether of bisphenol A. Preferred multifunctional epoxy resin include trifunctional epoxy resin based on para-aminophenol, meta-aminophenol, methylene dianiline, tetra-functional epoxy resin based on methylene dianiline, other multifunctional epoxy resin, and combinations thereof. In one preferred embodiment, the multifunctional epoxy resin is used in combination with liquid diglycidyl ether of bisphenol A to improve heat resistance performance.

Preferably, the at least one flame retardant is selected from the group consisting of ammonium polyphosphate, aluminum hydroxide, tributyl phosphate, tris(2-ethylhexyl) phosphate, tris(2-chloroethyl) phosphate, tricresyl phosphate, triphenyl phosphate, and 2-ethylhexyldiphenyl phosphate.

In another embodiment, the epoxy system further comprises at least one epoxy reactive diluent. Preferably, the at least one epoxy reactive diluent is selected from the group consisting of alkyl (C₁₂-C₁₄) glycidyl ether, p-tertiary butyl phenol glycidyl ether, cresyl glycidyl ether, 1,4-butanediol diglycidyl ether, cyclohexane dimethylol diglycidyl ether, resorcinol diglycidyl ether, trimethylol propane triglycidyl ether, glycerol triglycidyl ether, and neopentyl glycol diglycidyl ether. In one preferred embodiment, the epoxy reactive diluent is 1,4-butanediol diglycidyl ether.

Preferably, the mixing ratio of the at least one epoxy resin to the at least one epoxy reactive diluent is 50-99% to 1-50% by weight. In one preferred embodiment, the mixing ratio is 75%-95% to 5-25% by weight.

Preferably, the mixing ratio of curing agent composition to the at least one epoxy resin is 1-40% to 60-95% by weight. In one preferred embodiment, the mixing ratio is 10-25% to 75-90% by weight. The ratio of curing agent composition to the at least one epoxy resin is preferably the stoichiometric point.

The curing agent compositions can be produced with other fillers and additives. The epoxy system can also be produced with other fillers and additives. The curing agent composition and at least one epoxy resin is mixed for tests and composites fabrication. The additives include release agents, defoaming agents, leveling agents, coupling agents, other additives, and combinations thereof. In one embodiment, the additives could be premixed into the epoxy resin or curing agent or matrix to improve performance.

In another embodiment, the epoxy system further comprises a reinforcing fiber. Preferred examples of reinforcing fibers that can be used in the epoxy system include, but are not limited to, glass fibers, carbon fibers, ceramic fibers, polymeric fibers, polyester fibers, polyamide fibers, aramid fibers, or the like.

Fiber reinforced composites of the present invention comprise the epoxy system reinforced with fibers. The fiber reinforced composites are prepared in a process where the chopped fibers are impregnated within the epoxy system to form the sheet molding compounds (SMC). Preferably, the reinforcing fiber is present in the SMC in an amount ranging from about 10-60% by weight. In one preferred embodiment, the reinforcing fiber is present in the SMC in an amount ranging from about 20-40%.

### EXAMPLES

These Examples are provided to demonstrate certain aspects of the invention and shall not limit the scope of the claims appended hereto.

Epoxy systems described below were formed by blending epoxy resin and curing agent in a mixing device. The epoxy resin and curing agent can be prepared as one component packs.

Various terms and designations used in the following examples are explained and described in Table 1 as follows:

TABLE 1

| Material | Main compositions | Function | Supplier |
|---|---|---|---|
| NPEL 127 | Diglycidyl ether of bisphenol A, EEW 180 | Liquid epoxy | Nan Ya Plastics |
| | | resin (LER) | Corporation |
| Epodil 748 | Alkyl (C12-C14) Glycidyl Ether, EEW | Epoxy reactive | Evonik Specialty |
| | 285 | diluent | Chemicals |
| Epodil 750 | 1,4-Butanediol Diglycidyl Ether, EEW | Epoxy reactive | Evonik Specialty |
| | 128 | diluent | Chemicals |
| Epodil 762 | Trimethylol Propane Triglycidyl Ether, | Epoxy reactive | Evonik Specialty |
| | EEW 140 | diluent | Chemicals |
| AFG-90 | Trifunctional epoxy resin, EEW 110 | Liquid epoxy | Shanghai Huayi Resin. |
| | | resin (LER) | Co., Ltd |
| Dicyanex 1400F | Dicyandiamide | Curing agent | Evonik Specialty |
| | | | Chemicals |
| Amicure 7/10 | 1-Phenyl-3,3-dimethyl urea | Accelerator | Evonik Specialty |
| | | | Chemicals |
| Amicure UR-M | 4,4′-methylene bis (phenyl dimethyl urea) | Accelerator | Evonik Specialty |
| | | | Chemicals |
| Curezol 2MZ- | Modified imidazole | Accelerator | Evonik Specialty |
| Azine | | | Chemicals |
| Dyhard UR-700 | Modified urea | Accelerator | Alz Chemical |
| Ajicure PN-23 | Modified imidazole | Accelerator | Ajimoto |
| Vestalite S101 | Modified amine | Curing agent | Evonik Specialty |
| | | | Chemicals |
| Vestamin IPD | Isophorone diamine (IPD), AHEW 42.6 | Curing agent | Evonik Specialty |
| | | | Chemicals |
| Vestamin PACM | Bis(aminocyclohexyl)methane (PACM), | Curing agent | Evonik Specialty |
| | AHEW 52.6 | | Chemicals |
| PAT657BW | Release agent | Additive | Wuertz |
| EP-S-299 | Triacetondiamine | Curing agent | Evonik Specialty |
| | | | Chemicals |
| Jeffamine D230 | Polyoxypropylenediamine | Curing agent | Huntsman Corporation |
| EXOLIT AP 420 | ammonium polyphosphate | Flame | Clariant |
| | | retardant | |
| Calcium hydroxide | Calcium hydroxide | Reaction | Sinopharm |
| | | promotor | |
| Calcium oxide | Calcium oxide | Reaction | Sinopharm |
| | | promotor | |
| Calcium carbonate | Calcium carbonate | Reaction | Sinopharm |
| | | promotor | |
| Sodium hydrate | Sodium hydrate | Reaction | Sinopharm |
| | | promotor | |
| magnesium | magnesium hydroxide | Reaction | Sinopharm |
| hydroxide | | promotor | |
| barium hydroxide | barium hydroxide | Reaction | Sinopharm |
| | | promotor | |
| potassium hydrate | potassium hydrate | Reaction | Sinopharm |
| | | promotor | |
| DBU | DBU | Reaction | Evonik Specialty |
| | | promotor | Chemicals |

### Definitions and Test Methods

EEW is epoxy equivalent weight.
AHEW is amine hydrogen equivalent weight.
PHR is the use level of curing agent per hundred parts resin.
Stoichiometric point is the ratio of AHEW of curing agent to EEW of epoxy resin.
Viscosity was measured by Brookfield Viscometer according to ASTM D445-83
Glass transition temperature (Tg)
Glass transition temperature also known as Tg is measured by Differential Scanning Calorimetry (DSC) according to ASTM D 3418-82, heating rate of 10° C./min from 0 to 250° C. for example test. The midpoint of the steep portion of cure curve was taken as Tg. The DSC instrument utilized was a TA Instruments DSC Model Q2000.
Tg wet was determined on the second scan curve for wet mixtures.
Gel time test
Hot plate with a metal surface capable of temperature control of the surface temperature within ±1° C. of the set point. The hot plate was set at 150° C. for 30 min to stabilize. 1 ml of prepared sample was withdrawn and placed onto the plate, the timer was started immediately, and stroking began immediately with a wooden spatula. Stroking was done by gently pushing the resin to an area of about 7 cm*7 cm. The resin gradually thickened. The resin eventually became stringy and immediately after that became a rubbery gel which stuck to the spatula. At this point, the timer was stopped and the gel time was recorded.

Example Cured of SMC formulation with ammonium polyphosphate and reaction promotor The resin NPEL 127, hardener Dicyanex 1400F and PD, imidazole accelerator Curezol 2MZ-Azine, reaction promotor, and ammonium polyphosphate were mixed with a speed mixer machine to yield homogeneous resin vanish formulations. The gel time of SM formulation required before maturation is less than 140s and should be in the range of 60-90s after maturation. To keep good flame resistance of SMC material when used in the automotive or transportation industry, at least 6% flame retardant compared with liquid epoxy resin should be used. The formulations are shown in Table 2, below. From Table 2, ammonium polyphosphate degraded the reactivity of the epoxy SMC sample (SAH-2) and the addition of calcium hydroxide showed the best accelerating effect and good latency compared with the other promotor materials.

TABLE 2

| | | | | | | | | | | |
|---|---|---|---|---|---|---|---|---|---|---|
| System # | SAH-1 | SAH-2 | SAH-3 | SAH-4 | SAH-5 | SAH-6 | SAH-7 | SAH-8 | SAH-9 | SAH-10 |

Resin formulation

| | | | | | | | | | | |
|---|---|---|---|---|---|---|---|---|---|---|
| NPEL 127 | 100 | 100 | 100 | 100 | 100 | 100 | 100 | 100 | 100 | 100 |

Hardener formulation

| | | | | | | | | | | |
|---|---|---|---|---|---|---|---|---|---|---|
| Dicyanex 1400F | 4.6 | 4.6 | 4.6 | 4.6 | 4.6 | 4.6 | 4.6 | 4.6 | 4.6 | 4.6 |
| EP-S-299 | 8.42 | 8.42 | 8.42 | 8.42 | 8.42 | 8.42 | 8.42 | 8.42 | 8.42 | 8.42 |
| Curezol 2MZ-Azine | 1.5 | 1.5 | 1.5 | 1.5 | 1.5 | 1.5 | 1.5 | 1.5 | 1.5 | 1.5 |
| Calcium hydroxide | | | 1 | | | | | | | |
| Calcium oxide | | | | 1 | | | | | | |
| Calcium carbonate | | | | | 1 | | | | | |
| magnesium hydroxide | | | | | | 1 | | | | |
| Barium hydroxide | | | | | | | 1 | | | |
| sodium hydrate | | | | | | | | 1 | | |
| potassium hydrate | | | | | | | | | 1 | |
| DBU | | | | | | | | | | 1 |
| Hardener PHR | 14.52 | 14.52 | 15.52 | 15.52 | 15.52 | 15.52 | 15.52 | 15.52 | 15.52 | 15.52 |
| EXOLIT AP 420 | | 6 | 6 | 6 | 6 | 6 | 6 | 6 | 6 | 6 |

Process properties

| | | | | | | | | | | |
|---|---|---|---|---|---|---|---|---|---|---|
| Gel time @ | 101 | 423 | 109 | 113 | 178 | 112 | 112 | 91 | 92 | 152 |
| 150° C., s | | | | | | | | | | |
| (before maturation) | | | | | | | | | | |
| Gel time @ | 86 | 282 | 88 | 91 | 145 | 90 | 92 | 45 | 47 | Cured |
| 150° C., s | | | | | | | | | | |
| (7D room | | | | | | | | | | |
| temperature | | | | | | | | | | |
| storage) | | | | | | | | | | |
| Gel time @ | 62 | 182 | 65 | 68 | 88 | 69 | 68 | Cured | Cured | Cured |
| 150° C., s | | | | | | | | | | |
| (30D room | | | | | | | | | | |
| temperature | | | | | | | | | | |
| storage) | | | | | | | | | | |

### Example 2

In epoxy SM formulations, diamines are used as thickener to react with liquid epoxy resin to increase the viscosity of matrix during the maturation process. The epoxy SMC formulation will reach a stable B-stage with a range of viscosity that complies with storage and transportation requirements. As Table 3A shows, Vestamin IPD showed good balance between efficiency of maturation and latency when combined with liquid epoxy resin, DICY, Curezol 2MZ-Azine and calcium hydroxide. As Table 3B shows, the different ratio of IPD will have an effect on the reactivity as well as the latency of the epoxy SMC formulation when stored for 30 days at room temperature. For good handling properties, the epoxy SMC formulation should have the flexible status.

TABLE 3A

| | | | | |
|---|---|---|---|---|
| System # | SAH-11 | SAH-12 | SAH-13 | SAH-14 |

Resin formulation

| | | | | |
|---|---|---|---|---|
| NEPL 127 | 100 | 100 | 100 | 100 |

Hardener formulation

| | | | | |
|---|---|---|---|---|
| Dicyanex 1400F | 4.6 | 4.6 | 4.6 | 4.6 |
| EP-S-299 | 8.42 | | | |
| IPD | | 8.42 | | |
| D230 | | | 8.42 | |
| PACM | | | | 8.42 |
| Curezol 2MZ-Azine | 1.5 | 1.5 | 1.5 | 1.5 |
| Calcium hydroxide | 1 | 1 | 1 | 1 |
| Hardener PHR | 15.52 | 15.52 | 15.52 | 15.52 |
| EXOLIT AP 420 | 6 | 6 | 6 | 6 |

Process properties

| | | | | |
|---|---|---|---|---|
| Gel time @ 150° C., s (before | 101 | 99 | 175 | 135 |
| maturation) | | | | |
| Gel time @ 150° C., s (after | 86 | 77 | 102 | 103 |
| maturation) | | | | |
| Gel time @ 150° C., s (25° C., | 52 | 55 | 57 | 54 |
| 30D) | | | | |

TABLE 3B

| | | | | |
|---|---|---|---|---|
| System # | SAH-15 | SAH-16 | SAH-17 | SAH-18 |

Resin formulation

| | | | | |
|---|---|---|---|---|
| NEPL 127 | 100 | 100 | 100 | 100 |

Hardener formulation

| | | | | |
|---|---|---|---|---|
| Dicyanex 1400F | 4.6 | 4.6 | 4.6 | 4.6 |
| IPD | 8.42 | 7.5 | 7 | 6 |
| Curezol 2MZ-Azine | 1.5 | 1.5 | 1.5 | 1.5 |
| Calcium hydroxide | 1 | 1 | 1 | 1 |
| Hardener PHR | 15.52 | 14.6 | 14.1 | 13.1 |
| EXOLIT AP 420 | 6 | 6 | 6 | 6 |

Process properties

| | | | | |
|---|---|---|---|---|
| Gel time @ 150° C., s (before | 101 | 99 | 175 | 135 |
| maturation) | | | | |
| Gel time @ 150° C., s (after | 86 | 77 | 102 | 103 |
| maturation) | | | | |
| Gel time @ 150° C., s (25° C., | 52 | 55 | 57 | 54 |
| 30D) | | | | |
| The status of SMC material after | Rigid | Rigid | Flexible | Flexible |
| 30D room temperature | | | | |

### Example 3

In epoxy SMC formulations, accelerators are used to reduce the curing temperature and result in faster curing speed for DICY based epoxy systems. Meanwhile it will also have an effect on the latency and heat resistance performance. As Table 4A shows, Amicure UR-M has the best balance of reactivities and latency at room temperature storage compared with other accelerators, and a 2% ratio of Amicure UR-M compared with epoxy resin keeps flexible after 30 days room temperature storage.

TABLE 4A

| | | | | | |
|---|---|---|---|---|---|
| System # | SAH-19 | SAH-20 | SAH-21 | SAH-22 | SAH-23 |

Resin formulation

| | | | | | |
|---|---|---|---|---|---|
| NEPL 127 | 100 | 100 | 100 | 100 | 100 |

Hardener formulation

| | | | | | |
|---|---|---|---|---|---|
| Dicyanex 1400F | 4.6 | 4.6 | 4.6 | 4.6 | 4.6 |
| IPD | 7 | 7 | 7 | 7 | 7 |
| Curezol 2MZ-Azine | 1.5 | | | | |
| Amicure UR7/10 | | 1.5 | | | |
| Amicure UR-M | | | 1.5 | | |
| Dyhard UR-700 | | | | 1.5 | |
| Ajicure PN-23 | | | | | 1.5 |
| Calcium hydroxide | 1 | 1 | 1 | 1 | 1 |
| Hardener PHR | 14.1 | 14.1 | 14.1 | 14.1 | 14.1 |
| EXOLIT AP 420 | 6 | 6 | 6 | 6 | 6 |

Process properties

| | | | | | |
|---|---|---|---|---|---|
| Gel time @ 150° C., s | 101 | 95 | 95 | 170 | 142 |
| (before maturation) | | | | | |
| Gel time @ 150° C., s | 86 | 72 | 87 | 135 | 110 |
| (after maturation) | | | | | |
| Gel time @ 150° C., s | 52 | 60 | 75 | 102 | 63 |
| (25° C., 30D) | | | | | |
| The status of SMC | Rigid | Flexible | Flexible | Flexible | Rigid |
| material after 30D | | | | | |
| room temperature | | | | | |

### Example 4

TABLE 4B

| | | | | |
|---|---|---|---|---|
| System # | SAH-24 | SAH-25 | SAH-26 | SAH-27 |

Resin formulation

| | | | | |
|---|---|---|---|---|
| NEPL 127 | 100 | 100 | 100 | 100 |

Hardener formulation

| | | | | |
|---|---|---|---|---|
| Dicyanex 1400F | 4.6 | 4.6 | 4.6 | 4.6 |
| IPD | 7 | 7 | 7 | 7 |
| Amicure UR-M | 1 | 1.5 | 2 | 3 |
| Calcium hydroxide | 1 | 1 | 1 | 1 |
| Hardener PHR | 13.6 | 14.1 | 14.6 | 15.6 |
| EXOLIT AP 420 | 6 | 6 | 6 | 6 |

Process properties

| | | | | |
|---|---|---|---|---|
| Gel time @ 150° C., s (before | 106 | 95 | 92 | 80 |
| maturation) | | | | |
| Gel time @ 150° C., s (after | 98 | 87 | 83 | 62 |
| maturation) | | | | |
| Gel time @ 150° C., s (25° C., | 88 | 75 | 70 | 48 |
| 30D) | | | | |
| The status of SMC material after | Flexible | Flexible | Flexible | Rigid |
| 30D room temperature | | | | |

### Optimization of Hardener Compositions for the Requirements of Fast Cure, Good Latency, High Heat Resistance and Mechanical Properties

During SMC production, high curing efficiency is very important especially in the automotive industry. The gel time required during the molding process is in the range of 60-90s at 150 00 and depends on the design of the production parts. Meanwhile SMC is a two-step process for composites and the SMC material should have 30 days latency at room temperature to meet daily production requirements and the gel time after 30 days should be in the range of 60-90s. For the special requirements for the automotive and transportation industries, the glass transition temperature (Tg) should be higher than 120 00 and the mixed viscosity at 30 00 should be less than 2500 cps for good handling properties. As Table 5 shows, SAH-28 showed good handling properties (mixed viscosity and Tg after curing), and meets the cure speed and latency requirements.

TABLE 5

| | | | | | |
|---|---|---|---|---|---|
| System # | SAH-28 | SAH-29 | SAH-30 | SAH-31 | SAH-32 |

Resin formulation

| | | | | | |
|---|---|---|---|---|---|
| NPEL 127 | 90 | 85 | 95 | 90 | 90 |
| Epodil 748 | | | | 10 | |
| Epodil 750 | 10 | 15 | 5 | | |
| Epodil 762 | | | | | 10 |

Hardener formulation

| | | | | | |
|---|---|---|---|---|---|
| Dicyanex 1400F | 4.6 | 4.6 | 4.6 | 4.6 | 4.6 |
| IPD | 7 | 7 | 7 | 7 | 7 |
| Amicure UR-M | 2 | 2 | 2 | 2 | 2 |
| Calcium hydroxide | 1 | 1 | 1 | 1 | 1 |
| Hardener PHR | 14.1 | 14.1 | 14.1 | 14.1 | 14.1 |
| EXOLIT AP 420 | 6 | 6 | 6 | 6 | 6 |

Process properties

| | | | | | |
|---|---|---|---|---|---|
| Mixed viscosity/cps | 2495 | 2051 | 3058 | 2258 | 2964 |
| (30° C.) | | | | | |
| Gel time @ 150° C., s | 95 | 108 | 92 | 102 | 97 |
| (after maturation) | | | | | |
| Gel time @ 150° C., s | 70 | 73 | 68 | 75 | 72 |
| (25° C., 30D) | | | | | |
| Tg | 128 | 122 | 134 | 127 | 129 |
| The status of SMC | Flexible | Flexible | Flexible | Flexible | Flexible |
| material after 30D | | | | | |
| room temperature | | | | | |

TABLE 6

| | Invention | Comp | Comp | Comp |
|---|---|---|---|---|
| System # | Ex | Ex. 1 | Ex. 2 | Ex. 3 |
| NPEL 127 | 90 | 90 | 80 | 100 |
| AFG-90 | | | 10 | |
| Epodil 750 | 10 | 10 | 10 | |

Hardener formulation

| | | | | |
|---|---|---|---|---|
| Dicyanex 1400F | 4.6 | 4.6 | 4.6 | |
| Vestalite S101 | | | | 25 |
| IPD | 7 | 7 | 7 | |
| PAT657BW | 1.5 | | | |
| Amicure UR-M | 2 | 2 | 2 | |
| Calcium hydroxide | 1 | 1 | 1 | |
| Hardener PHR | 16.1 | 14.6 | 14.6 | 25 |
| EXOLIT AP 420 | 6 | 6 | 6 | 6 |

Process properties

| | | | | |
|---|---|---|---|---|
| Mixed viscosity/cps (30° C.) | 2320 | 2495 | 2284 | 857 |
| Demolding effect | Good | Poor | Poor | Poor |
| Gel time @ 150° C., s | 98 | 95 | 92 | 72 |
| (after maturation) | | | | |
| Gel time @ 150° C., s | 73 | 70 | 68 | 42 |
| (25° C., 30D) | | | | |
| Tg | 123 | 128 | 131 | 120 |

Mechanical performance without APP (80 C./1 h + 150 C./2 h)

| | | | | |
|---|---|---|---|---|
| Tensile strength/MPa | 85 | 84 | 89 | 80 |
| Tensile modulus/GPa | 2.5 | 2.6 | 2.8 | 2.4 |
| Tensile elongation/% | 5.2 | 5.3 | 4.2 | 5 |

As shown in Table 6, examples of the epoxy resin composition of the present invention improve demolding effect by adding additive. Further, when multifunctional epoxy resins are combined with Diglycidyl ether of bisphenol A resin, heat resistance performance as well as mechanical performance are improved.

1. A curing agent composition comprising dicyandiamide, at least one cycloaliphatic amine, at least one additive, at least one urea accelerator, and at least one inorganic alkali.

2. The curing agent composition according to claim 1, wherein the at least one cycloaliphatic amine is selected from the group consisting of metaxylylenediamine, 1,3-cyclohexanedimethylamine, N-aminoethylpiperazine, isophoronediamine, methylcyclohexanediamine, cyclohexylpropylenediamine, bis(aminocyclohexyl)methane, 1,2-cyclohexanediamine, and 3,3′-dimethyl-4,4-diaminodicyclohexylmethane, and combinations thereof.

3. The curing agent composition according to claim 2, wherein the at least one additive is selected from the group consisting of release agents, defoaming agents, leveling agents, coupling agents, other additives, and combinations thereof.

4. The curing agent composition according to claim 2, wherein the at least one urea accelerator is selected from the group consisting of 1 phenyl 3,3, dimethyl urea, 1,1′-(4 methyl-m-phenylene)bis (3,3-dimethylurea), 3-(3-chloro-4-methylphenyl)-1,1-dimethylurea, 3-(3,4-dichlorophenyl)-1,1-dimethylurea, 3-(4-chlorophenyl)-1,1-dimethylurea, 4,4′-methylene bis (phenyl dimethyl urea), and combinations thereof.

5. The curing agent composition according to claim 2, wherein the at least one inorganic alkali is selected from the group consisting of calcium carbonate, calcium oxide, calcium hydroxide, magnesium hydroxide, barium hydroxide, potassium hydrate, magnesium oxide, barium oxide, potassium oxide, sodium hydroxide, and combinations thereof.

6. An epoxy system prepared from at least one epoxy resin, at least one flame retardant and the curing agent composition according to claim 2.

7. The epoxy system according to claim 6, wherein the at least one epoxy resin is selected from the group consisting of liquid diglycidyl ether of bisphenol A, liquid diglycidyl ether of bisphenol F, phenol novolac epoxy resin, multifunctional epoxy resins, and combinations thereof.

8. The epoxy system according to claim 7 wherein the multifunctional epoxy resin is selected from the group consisting of trifunctional epoxy resin based on para-aminophenol, meta-aminophenol, or methylene dianiline, tetra-functional epoxy resin based on methylene dianiline, and combinations thereof.

9. The epoxy system according to claim 6 wherein the at least one flame retardant is selected from the group consisting of ammonium polyphosphate, aluminium hydroxide, tributyl phosphate, tris(2-ethylhexyl) phosphate, tris(2-chloroethyl) phosphate, tricresyl phosphate, triphenyl phosphate, and 2-ethylhexyldiphenyl phosphate.

10. The epoxy system according to claim 6 further comprising at least one epoxy reactive diluent selected from the group consisting of alkyl (C₁₂-C₁₄) glycidyl ether, p-tertiary butyl phenol glycidyl ether, cresyl glycidyl ether, 1,4-butanediol diglycidyl ether, cyclohexane dimethylol diglycidyl ether, resorcinol diglycidyl ether, trimethylol propane triglycidyl ether, glycerol triglycidyl ether, and neopentyl glycol diglycidyl ether.

11. The epoxy system according to claim 10 wherein the mixing ratio of the at least one epoxy resin to the at least one epoxy reactive diluent is 50-99% to 1-50% by weight.

12. The epoxy system according to claim 6 wherein the mixing ratio of the curing agent composition to the at least one epoxy resin is 1-40% to 60-95% by weight.

13. The epoxy system according to claim 6 further comprising a reinforcing fiber.

14. The epoxy system according to claim 13 wherein the reinforcing fiber is selected from the group consisting of glass fibers, carbon fibers, ceramic fibers, polymeric fibers, polyester fibers, polyamide fibers, aramid fibers, or the like.

15. The epoxy system according to claim 10 further comprising a reinforcing fiber.

16. The epoxy system according to claim 15 wherein the reinforcing fiber is selected from the group consisting of glass fibers, carbon fibers, ceramic fibers, polymeric fibers, polyester fibers, polyamide fibers, aramid fibers, or the like.
